(19) United States
(12) Patent Application Publication
(10) Pub. No.: US 2026/0004600 A1
(43) Pub. Date: Jan. 1, 2026

(54) IMAGE AUTHENTICATION

(71) Applicant: KELLER SERVICES - FZCO, Dubai (AE)

(72) Inventor: Vasily Kulkov, Moscow (RU)

(21) Appl. No.: 19/320,665

(22) Filed: Sep. 5, 2025

Related U.S. Application Data
(63) Continuation-in-part of application No. PCT/IB2025/050784, filed on Jan. 24, 2025.

(30) Foreign Application Priority Data
Jan. 24, 2024 (GB) 2400948.2

(51) Int. Cl. G06V 20/00; G06T 1/00; G06V 10/74; G06V 10/776; G06V 10/94

(52) U.S. Cl. CPC G06V 20/95; G06T 1/0021; G06V 10/761; G06V 10/776; G06V 10/95

(57) ABSTRACT

A system for managing the application of artwork to a substrate, the system comprising one or more processors configured to: receive an indication of a graphic; generate a set of candidate locations for markers visually differentiable from the graphic; transmit the candidate locations to a graphic applicator; receive from the applicator an image of a target substrate region having visually differentiable markers applied thereto; and compare the locations of the markers in the image with the candidate locations.

### CROSS-REFERENCE TO RELATED APPLICATIONS

This application is a continuation-in-part of PCT Application No. PCT/IB2025/050784, filed Jan. 24, 2025, which claims priority to GB Application No. 2400948.2, filed Jan. 24, 2024, each of which is hereby incorporated herein in their entirety for all purposes.

### FIELD

The present description relates to authenticating images, for example manually drawn images.

### BACKGROUND

It is possible to buy art images in the form of paintings or drawings on portable media such as paper or canvas. Art in this form can be made by a prominent artist and then transported to a buyer. Some forms of art are not transportable in this way. For example, tattoos and murals must be made on a specific substrate, so it is not feasible to have them made by a remote artist.

It is desirable to be able to authenticate images, for example so that it can be reliably determined that they have derived from a specific artist. Often an artist will sign a work, but authenticating a signature requires expert analysis.

Machine-readable codes such as barcodes are known. However, in general they are unsuitable for authenticating art, especially manually drawn art, because they are either so simple as to be easily reproduced or, in the case of typical two-dimensional barcodes, so complex that it is difficult for an artist to manually reproduce the barcode with sufficient precision that it can be reliably read. It is often undesired to have a machine-readable identifier incorporated into an artwork, as identifiers such as QR codes may detract from the visual style of the artwork. Equally, if a machine-readable identifier is removably applied to an artwork, for example an adhesive barcode applied to the back of a canvas, the identifier may be removed, altered, forged or otherwise be unfit for purpose.

There is a need for an improved system for authenticating images, including manually drawn images.

### SUMMARY

According to one aspect there is provided a system for managing the application of artwork to a substrate, the system comprising one or more processors configured to: receive an indication of a graphic; generate a set of candidate locations for markers visually differentiable from the graphic; transmit the candidate locations to a graphic applicator; receive from the applicator an image of a target substrate region having visually differentiable markers applied thereto; and compare the locations of the markers in the image with the candidate locations.

The one or more processors may be configured to: if the comparison indicates conformity between the markers in the image and the candidate locations, transmit an instruction to the applicator to apply the graphic to the target substrate; and otherwise, transmit an instruction to the applicator to apply a further marker to the substrate.

The one or more processors may be configured to perform image processing on the received image of the target substrate region to identify the locations of markers in that image.

The one or more processors may be configured to store the set of locations of the markers in the image in association with data indicative of a transaction by which the graphic is authorised to be applied to the target substrate.

The one or more processors may be configured to, subsequent to the said storing step: receive from a user terminal a second image of the target substrate having the graphic and the markers thereon; process the second image to identify the locations of markers in that image; compare those identified marker locations with sets of stored marker locations to identify a match between the identified marker locations and a set of stored marker locations; and in response to identifying such a match, transmit associated data indicative of a transaction to the user terminal.

The system may store sets of marker locations for previously applied graphics, and the step of generating a set of candidate locations for markers may comprise: determining a target quantity (n) of candidate locations; and determining n candidate locations subject to the constraint that any set of n markers located such that each such marker is offset from a respective one of the candidate locations by not more than a predetermined deviation is distinct from all of the stored sets of marker locations.

The predetermined deviation may be a two-dimensional deviation. It may be a deviation in the plane or local plane of a substrate.

The marker may be circular or square.

The greatest dimension of each marker may be less than 5 mm.

The graphic applicator may be a human.

The target substrate may be part of the skin of a human subject.

The system may comprise an applicator for dispensing a medium for applying the artwork and the or each processor may be configured to, if the comparison indicates conformity between the markers in the image and the candidate locations, transmit a signal to the applicator for permitting the applicator to dispense the medium.

The or each processor may be configured to, if the comparison indicates conformity between the markers in the image and the candidate locations, determine an amount of the medium in dependence on the graphic and transmit a signal to the applicator for permitting the applicator to dispense that amount of the medium.

The one or more processors may be configured to: if the comparison indicates conformity between the markers in the image and the candidate locations, transmit to the applicator an indication of a location relative to the markers at which the graphic is to be applied to the target substrate.

According to a second aspect there is provided a method for applying an artwork to a substrate, the method comprising: receiving an image; receiving an indication of a set of marker positions; applying markers to the substrate, each marker being applied in a region of a respective one of the indicated marker positions; recording the positions of the markers as applied to the substrate; and applying the image to the substrate in the region of the markers.

According to a third aspect there is provided a tattoo applicator comprising: an inlet for receiving ink; a needle for applying ink to a substrate; a valve located in a flow path between the inlet and the needle for controlling the flow of ink between the inlet and the needle; a communication interface for receiving data over a data network; and one or more processors coupled to the interface and the valve, the processors being configured to process a message received at the communication interface to authenticate that message, and in response to the message being authenticated and the message being of a predetermined form, cause the valve to open

According to a fourth aspect there is provided a computer program and/or a data carrier storing a computer program, the program being adapted for causing one or more processors to perform a function set out above.

### DESCRIPTION OF THE DRAWINGS

Aspects are described herein by way of example with reference to the accompanying drawings. In the drawings:

FIG. 1 is a schematic diagram of a system for the provision and authentication of images according to one or more illustrative aspects described herein.

FIG. 2 shows an example of an image including authentication markers according to one or more illustrative aspects described herein.

FIG. 3a shows an example of windows and intended marker locations according to one or more illustrative aspects described herein.

FIG. 3b shows an example of applied markers according to one or more illustrative aspects described herein.

### DETAILED DESCRIPTION

The following description is presented to enable any person skilled in the art to make and use aspects described herein and is provided in the context of a particular application. Various modifications to the disclosed aspects will be apparent to those skilled in the art. The general principles defined herein may be applied to other aspects and applications without departing from the present disclosure. Aspects are described by way of example only.

In one example of the system to be described below, a user can browse an online marketplace of images and select an image for purchase. Then the user can engage an artist to manually reproduce that image on a specific substrate. Before or as the artist is reproducing the image, the system guides the artist to incorporate markers in the image. The markers may be applied before other components of the image are applied. Alternatively, some or all of the image may be applied before the markers are applied. The system records the disposition of the markers. Subsequently, the markers can be used to authenticate the image, for example as having properly been derived from the original creator of the image.

The original image could be drawn by a human artist or generated by another entity such as a suitably programmed computer. The image could be acquired through the online marketplace or in other ways, for example in a physical shop or store. The image could be applied manually, which includes by a person physically manipulating a mechanical applicator such as a tattoo applicator, or by a machine such as a robotic arm which moves an applicator under program control.

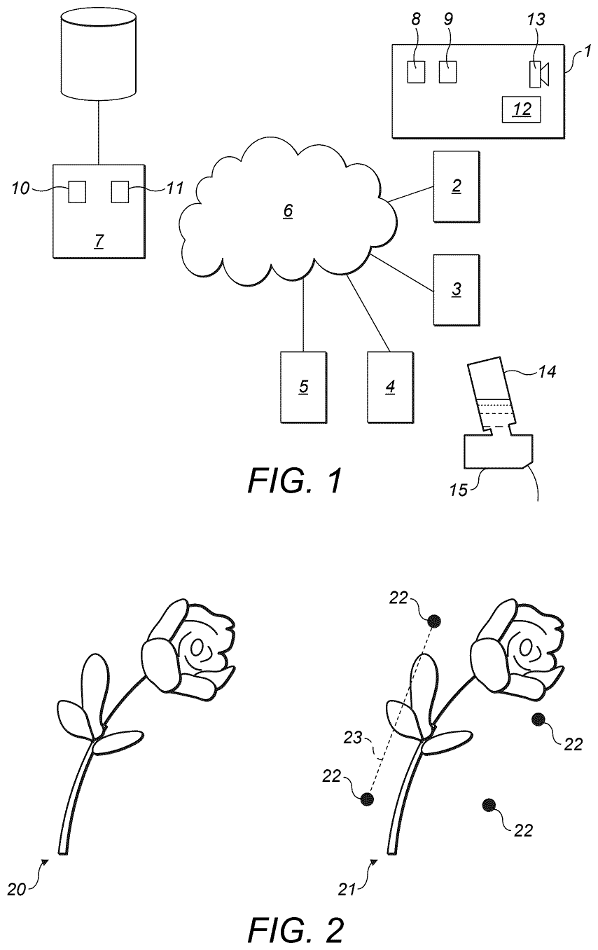

FIG. 1 shows a distributed system including multiple terminals 1 to 5 connected via a network 6 to a server 7. The terminals could, for example, be cellular phones, tablets, personal computers. The server could be implemented by one or more computer devices which could be co-located or distributed across multiple locations. Each terminal has a processor 8 and a memory 9 storing in non-transient form instructions executable by the processor to cause the processor to implement the functions of the terminal as described below. Each computer device of the server has a processor 10 and a memory 11 storing in non-transient form instructions executable by the processor to cause the processor to implement the functions of the server as described below. The memory 11 of the server also stores a database for holding information on available art, applied markers, artist details and so on. Each terminal may comprise a display 12 for displaying information including images and a camera 13 for capturing images. The terminals and the server may communicate with the network using any suitable data link: for example, wired or wireless data links. The network may be, at least in part, a publicly accessibly network such as the internet.

The operation of the system of FIG. 1 will now be described.

First, artists create images, also known as graphics, either electronically on an artist's terminal 1 or using physical media. Images made using physical media can be scanned or photographed using a camera, which may be integrated into the artist's terminal 1. An artist registers with the server 7 and then uploads a created image to the server 7. The artists may be subject to a verification process to determine whether the images may be uploaded to the server 7, and/or whether collaboration is possible with applicators. The server 7 stores the image, together with details of the artist such as their name, location and biography. The artist may designate a price for the image which is also stored by the server 7. The server 7 may store information about the image, such as its style, size and subject matter. Many images can be collected in this way at the server. The server 7 may store a profile for an artist that includes information about the artist and their artwork. The profile may be created after the artists receives approval through the verification process. The artist may upload new designs to their profile to be displayed on the platform. The artist profile and uploads may be reviewed by operators of the server 7 to ensure artist compliance with the platform.

An end user can connect to the server 7 using an end user's terminal 2. On the end user's terminal 2 the end user can browse images stored on the server 7, together with the details stored for each image. On finding a suitable image the end user may decide to buy the image, or a licence to it, for application to a suitable substrate by a reproducer. As will be discussed below, the substrate could be a substrate to which the end user has access. The reproducer could be a person or a machine. The reproducer may be the same person as the end user. The reproducer may also be referred to as an applicator. In some instances, a corresponding financial transaction is undertaken between the end user and an operator of the server. In that transaction the end user pays the operator of the server for access to the image. Upon receipt of payment, the operator may vend the image in a suitable format, such as a digital file for download by the end user or by the reproducer/applicator. Then the operator of the server may pay the artist who created the image. Alternatively, the transaction might not involve any payment at all. The end user may be prompted, either during purchasing or when contacting a reproducer, to indicate whether an identifier should be applied along with the image. The end user may choose to include an identifier, or alternatively, may choose to omit the identifier. If the end user chooses to include the identifier, the server may provide the end user with additional options regarding the identifier such as size, placement, or other features of the identifier that will be discussed in more detail below.

Once the end user has appropriately obtained the image, they can engage a reproducer to reproduce the image on the intended substrate. If the substrate is mobile, for example if the substrate is the end user's skin and the intention is for the image to be reproduced as a tattoo on the end user's skin, then the end user may visit the reproducer to have the selected image reproduced. If the substrate is immobile, for example if the substrate is a wall and the intention is for the image to be reproduced as a mural on the wall, then the reproducer may visit the location of the wall. The server 7 may facilitate the introduction of the end user to a reproducer who is appropriately situated and has the appropriate skills to reproduce the image on the desired substrate. The stored information related to the image (e.g. style) may be used to produce a candidate list of reproducers for selection by the end user. The reproducer may, for example, be a tattoo artist or a mural artist. The reproducer may have particular specialisms, such as styles of tattooing. The end user may themself be a reproducer of the image. The reproducer may be or may use a machine to perform the reproduction.

The reproducer accesses the server to obtain the image that is to be reproduced. If the reproducer is a human artist then they can use a reproducer's terminal 3 to view the image. At this stage, the server may begin the process of enabling the image to be authenticated. Alternatively, this process may be done at another time.

If the end user elected to include an identifier with the image, the server may provide the reproducer with instructions for applying an identifier. The instructions may include details of the identifier to be applied such as the makeup of the identifier, a size of the identifier, the placements of the identifier, to relation of the identifier to other aspects of the image, and/or any other aspects of the identifier as discussed below. The instructions may include one or more of these features. For example, the server may provide instructions that the identifier should comprise a number of fiducial markers (e.g., five) of a certain size (e.g., applied with a needle between size 3-5 gauge or a grouping of 3-5 needles) that are spaced a specific distance from each other. The preferred grouping is 3-5 needles, but may be any appropriate needle size for each specific application. For example, a larger needle size (or larger grouping of needles) may be used for a larger image (e.g. a back tattoo). In some instances, when not specified in the instructions, the reproducer may select the location of the identifier. The server may check with previously applied images to determine locations an identifier should not be applied and provide indication of areas to avoid placing the identifier in the instructions. The reproducer should place the identifier such that it identifies that image as being applied to a particular substrate. The selection of a location of the identifier by the server is discussed in more detail below.

FIG. 2 shows at 20 an image that may have been bought or obtained by an end user. To allow the image to be authenticated, the server determines a set of locations for fiducial markers that can be incorporated into the image. FIG. 2 shows at 21 an example of the same image incorporating fiducial markers 22.

In some embodiments, the server selects a set of locations for the fiducial markers that can be determined to be unique in comparison to other location sets that the server is already aware of. Those other location sets may be location sets associated with images that have already been reproduced and whose details are stored by the server. To do this, the server may use one or more of the following criteria in any order or combination.
1. The server may select a desired number of fiducial markers to be incorporated into the image. The server may select a desired number of fiducial markers based on attributes of the image such as the size, intricacy, and intended substrate. In some instances, the server may determine a desired number of fiducial markers based on the server's ability for recognizing identifiers in recorded images. The server may compare the attributes of the image with image processing software parameters for detecting the markers to refine the selection of a desired number of markers. For example, the server may select fewer markers based on the image being a 40 mm by 40 mm tattoo intended to be placed on an arm, and more markers when the image is 100 mm by 100 mm or larger and intended to be placed on someone's back. In one example, the number of fiducial markers may be determined in dependence on another attribute stored in the database in association with the image. For example, the greater the price of the image, more or fewer markers might be selected. In some instances, the server may determine a number of desired fiducial markers based on a geometric arrangement of the markers to be applied. For example, if the server determines that the markers are to be arranged in a geometric pentagon pattern, the server will select five markers for incorporation.
2. The server may select the locations such that the set of locations is different from any of its previously stored sets, optionally taking into account that the reproducer might introduce some error when positioning the markers. For example, a window of a predetermined shape and size may be defined for each proposed marker. The server may then determine a set of locations that are at the centre of such windows, the windows being such that wherever a marker is located in the respective window, the resulting set of markers will be distinct from previously stored sets. The windows may, for example, be round or square in shape. The windows may, for example, have a greatest dimension of 3 mm, 5 mm or 10 mm, or other suitable size based on the substrate (e.g., marker windows on murals might be larger than marker windows on skin). The greatest dimension could be higher or lower than these values, suitably being selected depending on the technique being used to apply the image and its expected precision. In some instances, the server may select the set of locations based on the image processing software for recognizing markers. For example, the server may select locations based on specific distortions (e.g., angle, distance, shape, pattern, and/or spatial relationship) of previously placed images being distinguishable by a image and/or pattern recognition algorithm used by the image recognition software.

To illustrate the process in more detail, suppose the server is storing the following marker positions for previously reproduced images, the positions representing distances in mm on orthogonal X and Y axes from a reference location:
Image 1: [3.4,1.2], [6.0,1.3], [11.1,7.6]
Image 2: [0.2,10.9], [5.7, 2.9], [5.5, 4.0]
Image 3: [9.0, 13.4], [11.8, 15.8], [5.0,4.0], [14.3, 7.1]

To determine the locations for a new set of markers, the server first determines how many markers are to be in the new set, for instance three. The server may have selected five markers based on being able to recognize the identifier compared to the size and intricacy of the image. Suppose the marker is to be a square 1 mm×1 mm. Suppose the window size to accommodate imprecision in drawing the marker is a 5 mm×5 mm square. Suppose the server is pre-configured to assume that markers will be considered distinct if they are more than 1 mm away from each other. These criteria can suitably be decided when implementing the present system, depending on the technique being used to apply the image, its expected precision and the degree of accuracy desired in authenticating images. Then the server determines the selected number of locations such that when a single marker is placed at any location in each of the windows, a pattern will result whose markers are distinct from the set of markers in each of the already-stored sets. The server may check previously applied markers to ensure there is no overlap between different sets of markers. In some instances, the server may transform an already-stored set of markers to determine a distinct set of new markers. In doing this, the server may consider rotation of the determined set of positions, so that it is distinct from the already-stored sets in any orientation. It may also consider sub-sets of markers in already-stored sets of markers, so that the newly determined set as a whole will be distinct from any subset of markers in an already-stored set. The server may transform already-stored sets of markers using other transformations (e.g., scaling or warping) as determined by one or more algorithms. The server determines the positions relative to the graphic so that the markers will be distinguishable from the graphic once applied. Thus, each marker may be spaced or offset from non-blank parts of the graphic that is to be applied, or may be in a different colour from adjoining parts of the graphic. The spacing may be determined based on the relative distance of each marker from the image and each other in accordance with one or more image and/or pattern recognition algorithms. The markers or parts of them could be reversed out of the graphic. If desired, one or a set of the markers may be directionally specific, for instance in the shape of a line, arrow or L-shape. This can allow an entity that is visually assessing the markers to establish a specific orientation and avoid the need for multiple possible rotational configurations of the pattern to be considered. In some instances, the server may analyse the substrate for other images to determine marker positions that will be distinguishable. For example, a user may have one or more tattoos surrounding the area for application, and the server may determine marker positions that will be distinguishable from the current image and already applied images.

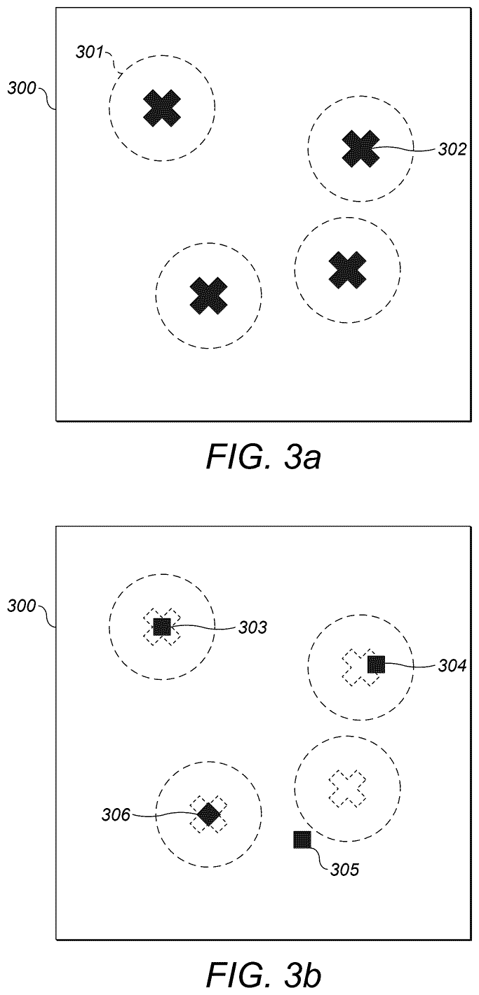

Once the server has determined a suitable set of marker locations, it presents the set of marker locations to the reproducer, e.g. via the reproducer's terminal 3. The markers may be represented as an overlayed layer in the digital image. The markers may be accentuated by being, for example, a different colour from a majority of the image, or the lines of the image, or having a greater local density than other areas of the image. The reproducer then attempts to apply markers to the substrate in those locations. In practice, due to factors such as unevenness of the substrate and the imprecision associated with manual drawing, the markers might not be placed precisely as indicated to the reproducer. However, if the reproducer is capable of placing the markers within the predetermined windows then the pattern of markers will still be unique due to the manner in which the marker locations were selected, as described above. Such placement will be discussed in relation to FIGS. 3a and 3b below.

In some embodiments, the server may not select the location of the markers. The location of the markers may be determined by the reproducer. The reproducer, upon receiving the image to be applied, may select locations for the markers. For example, the reproducer may arrange the markers to form a specific pattern or shape on or around the image. The reproducer may receive instructions that provide guidelines for selection of the location of the markers. The guidelines may include, distances relative to other markers, distances relative to the image, prohibited configurations (e.g., a configuration is already associated with a previous application of the image), and/or any other guidelines to ensure the markers are identifiable.

Once the reproducer has laid down the markers, it may be advantageous to record the position of the markers as laid down. This can help to identify the markers later, and can afford the server greater flexibility in defining marker positions for subsequent artworks. The reproducer may use their terminal 3, or another terminal 4 such as a mobile phone, or a dedicated camera, to photograph the markers as laid down on the substrate. Then the reproducer can transmit that photo to the server. The server can then verify that the markers as laid down are within the predetermined windows and/or are distinguishably unique among the art for which it stores marker data. This may be done before the image and markers are applied to the substrate. For example, the reproducer may record the positions of the markers stencilled onto the substrate before permanently applying them. If the markers as laid down are not distinguishably unique, e.g. due to errors in their positioning by the reproducer, then the server may instruct the reproducer to apply one or more additional markers to generate a distinguishably unique pattern. In the example where the markers are recorded when stencilled prior to application, the server may alert the reproducer to reapply the stencil in the appropriate location. The server stores the locations of the markers as laid down in association with the end user's purchase of the image. If an image of the markers is not transmitted to the server then the server can store the marker positions as instructed to the reproducer in association with the end user's purchase of the image.

The markers may be applied and photographed for identification prior to the image being reproduced. Alternatively, the markers may be laid down contemporaneously with other features of the image being reproduced. It may be that the completed image partially or fully overlaps the markers.

The reproducer can then apply the image itself to the substrate. The server may instruct the reproducer on the location where the image is to be applied relative to the markers. To logically associate the image with the markers, the image may be positioned so that for one of the markers there is a non-blank part of the image located on a straight line across the substrate running between that marker and another one of the markers. With the image between two of the markers in this way, it can be plain that the markers are associated with that image. To more emphatically associate the markers with the image, it may be the case that for each of the markers there is at least one other marker located such that the straight line across the substrate between the marker in question and that other marker intersects a non-blank part of the image. A non-blank part of the image may be a part applied by the reproducer. Put another way, for at least one of the markers there may exist a straight line (23 in FIG. 2) across the substrate which extends from that marker to another one of the markers and also passes through a non-blank part of the image. This may be true for multiple of the markers, or even for each of the markers there may exist a straight line across the substrate which extends from that marker to another one of the markers and also passes through a non-blank part of the image

Once the image is complete the reproducer may capture another photograph of the completed artwork, including the markers, and transmit that to the server as a record of successful completion. Preferably, the entire image is captured in a photograph. However, for larger artworks, only a portion of the image containing the markers may be captured in a photograph. The photograph of the image may be uploaded to the server. The reproducer may identify the markers in the photograph when it is uploaded. In some instances, where the reproducer selected the location of the markers, it may be necessary for the reproducer to identify the marker locations. The reproducer may identify the locations of the markers when stencilled to the substrate, or after the image has been applied to the substrate. The reproducer may identify the location of the markers in the uploaded image by selecting each marker. For example, the reproducer may view the uploaded image and circle the locations of each marker (e.g., via touchscreen input of a mobile device). The photograph of the completed artwork may be associated with a stored file of the image on the server. The photograph may be accessible to users browsing the image marketplace as an example of the image applied to a substrate.

At a later time, the end user or a third party can verify the artwork as applied to the substrate, for example to check that it derives from the original artist. To do this the party in question can use a terminal, e.g. a mobile phone, to capture an image of the artwork as applied to the substrate, including the markers, and transmit that image to the server. The server can then process the image to identify the positions of the markers, and compare those marker positions to the marker positions stored in its database. The comparison may take into account distortions, e.g. trapezoidal distortion due to variance between the camera image plane and a plane of the substrate and rotation. If there is a match then the server can report to the terminal 5 details of the artwork and/or transaction that were matched, for example the artist, the purchase date and the purchaser. In this way it can be verified that the artwork as applied to the substrate has derived properly from the artist.

The markers may be of any suitable shape and size. For example, they could be dots, crosses, full or open squares, full or open circles, full or open ovals or lines. Any suitable number of markers may be used. Conveniently the number of markers may be in the range from three to 15. The number of markers may be in the range four to 10. The markers may be of any suitable size, e.g. a size that permits them to be identified reliably. For example, the markers may be 1 mm square or 1 mm diameter; or may have a greatest dimension that is not greater than 5 mm and/or a smallest dimension that is not less than 1 mm. The markers may be deposited in the same medium as the image, for example ink or paint. In the preferred embodiment, 5 circle markers are applied in black ink.

The designation of marker positions and windows within which each marker should be situated will be discussed with reference to illustrative FIGS. 3a and 3b. FIG. 3a shows an image area 300 and windows 301 indicated as circular areas. Within each window 301 there is an intended marker position 302 indicated as a solid cross. The centre of the intended marker position 302 is central to a respective window 301.

FIG. 3b illustrates an equivalent image area 301 as in FIG. 3a. Marker 303 is shown as ideally applied, at the intended marker position 302 (the centre of the cross) within the window 301. Marker 304 is shown as offset from the intended marker position, but still within the defined window. Such a marker can be considered to have been successfully applied according to being within the predetermined window generated by the server. Marker 305 is shown as located outside a respective window 301, such a marker can be considered to have been unsuccessfully applied. Marker 306 is shown having a different rotational orientation compared to markers 303, 304 and 305. The marker 306 can be assessed in terms of orientation relative to other markers. As discussed above, the orientation of markers to be applied may be specified by the server in order to generate a unique set of markers.

To assist the reproducer in accurately positioning the markers, the reproducer's terminal may provide a template, for example in the form of an adhesive mask that can be applied to the substrate to guide application of the markers, or it may project the intended marker positions on to the substrate. The reproducer's terminal may be configured to cause a thermal printer to print a transfer image for tattooing.

The server is provided with software for detecting the markers in images provided to it. This may be any suitable image processing software, for example software trained by machine learning to detect the markers. Such software can conveniently be trained by assembling a set of images of artworks analogous to the ones that are to be reproduced, artificially applying markers to those images in known locations to form a set of training images, and training the machine learning algorithm to detect the markers in the known locations in the training images.

Another application of the system described above is in surgery. Tattoos can be used to mark sites on or in the human body at which surgery is to be performed. Tattoos are used particularly for applying markers for radiation therapy. This can reduce the chance of mistakes by a surgical procedure being performed on the wrong patient or in the wrong location. Using the system as described above, in a pre-surgical step a healthcare professional (HCP) identifies a site for surgery. The HCP communicates with the server to register a target image for the surgical site, analogously to the end user as described above obtaining an artwork. The server determines a distinguishably unique set of markers, as described above, and instructs the HCP to apply the markers at the surgical site together with the target, analogously to the reproducer applying markers and an image. The markers may be recorded in the server's database together with details of the patient to whom the markers were applied and/or the intended surgical procedure. At a later time, an HCP who is to perform surgery can identify the target and validate the markers by sending an image of them to the server. The server can return the information stored about that set of markers. In that way, the HCP who is to perform the surgery can check that the correct patient is at hand and/or that the correct procedure is to be undertaken.

Algorithms for identifying suitable marker locations to be advised to the reproducer will now be described.

The server has access to a database of previously registered sets of markers. Each set of markers may be stored as a set of coordinates for each marker, for example X and Y coordinates. If the system is to be used with substrates that are substantially non-planar then a projection of the markers on to a plane may be considered, or the server may make use of data defining the three-dimensional shape of the substrate, e.g. as provided to it by a LIDAR scan of the substrate made by the end user or the reproducer. The server stores data defining zones of potential inaccuracy in the application and/or identification of a marker. In the case of application, it is possible that the reproducer might apply a marker in a position somewhat offset from an intended position. In the case of identification, it may be that due to camera resolution, camera lens distortion or non-planarity of the substrate there is a difference between the position at which the server identifies a marker in an image and the actual position of the marker, either absolutely or relative to nearby markers. These zones of potential inaccuracy may conveniently be considered to be square or round. They may be ascribed the same or different widths. They may be considered separately, or a larger zone of potential inaccuracy may be employed to account for both sources of inaccuracy. In one example, to determine suitable locations at which to instruct the reproducer to place markers, the server identifies a set of locations such that with a respective marker placed anywhere in a window of a predefined shape and size about each of those locations, those placed markers will form a pattern that is distinct from any of the previously stored patterns, or any subset of the previously stored patterns. The latter condition allows later-applied patterns with fewer markers than earlier-applied patterns to nevertheless be distinguished from the prior patterns. In addition to choosing the positions of the markers, the server may instruct that markers of different sizes or shapes should be applied. The distinguishable uniqueness of a pattern of markers may take into account the shape and/or orientation of the markers. This may allow further variations in pattern to be achieved.

It may be desirable to use a specific medium to apply the markers and/or the image to the substrate. For example, it may be desirable to use an ink of the type described in our co-pending GB patent application No. 2400946.6 entitled “A Particle”. In some circumstances it may be advantageous to securely associate the dispensing of the medium with the application of a specific image. This may be achieved as follows. The reproducer is provided with a supply of the medium, e.g. in a reservoir 14 such as a bottle. The reproducer attaches the reservoir to a dispensing device 15, e.g. a tattooing machine or a paint spray gun. The reservoir may be physically configured, e.g. with a neck of a specific shape, so that it can only mate with certain dispensing devices. The dispensing device is configured only to dispense medium when suitably authorised. The dispensing device communicates with the server. When the end user gains access to an image for application by a reproducer, the end user communicates to the server the identity of the reproducer who is to be engaged. The dispensing device is logically associated at the server with that reproducer. When the reproducer uses their terminal to contact the server to initiate the process of applying the image, as described further above, the server communicates with the dispensing device to authorise it to dispense an amount of the medium. The amount of the medium to be dispensed may be determined by the image. For example, an image for a tattoo having a size of 10×10 cm and only outlines, without shading, may have an associated ink volume of 5 cm3. In this way, the use of the medium can be reliably constrained to images acquired in the manner described above. A volume of a specific medium for applying only the markers may be dispensed. For example, a tattoo ink having a particular colour.

In the examples given above, it is described that the graphic is applied to the substrate by a human operator. The human operator could use a drawing tool such as a needle, pencil, pen, brush or spray. Alternatively, the reproducer could be an automated device such as a printer or a robotic drawing tool. If the reproducer is an automated device, it may be provided with the marker positions by the server over a suitable communications link. It may attempt to apply the markers in the designated positions, or as close as it can given any factors such as unevenness of the substrate, and then automatically capture an image of the markers and return it to the server for verification analogously to the process described above. It may be provided with the image by the server, and it may then automatically apply the image to the substrate, in association with the markers. The robotic device may, for example be an automated tattoo applicator.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present disclosure may consist of any such individual feature or combination of features. In view of the foregoing description it will be evident to a person skilled in the art that various modifications may be made within the scope of the aspects described herein.

The phrase “configured to” or “arranged to” followed by a term defining a condition or function is used herein to indicate that the subject of the phrase is in a state in which it has that condition, or is able to perform that function, without that object being modified or further configured.

What is claimed is:

1. A method comprising:
receiving, by a server and from a user, a request to include an identifier in an artwork;
sending, to a graphic applicator device and in response to the indication, instructions for applying the identifier to a substrate;
receiving, from the graphic applicator device, a graphic image depicting the artwork as applied to a particular substrate;
detecting an applied identifier in the graphic image; and
sending, to the graphic applicator device, a confirmation that the applied identifier corresponds to the requested identifier.

2. The method of claim 1, further comprising:
receiving, from the user, information associated with the graphic image; and
storing a record associating the information with the applied identifier corresponding to the graphic image.

3. The method of claim 1, further comprising storing a record identifying the artwork as being applied to the particular substrate when a predetermined condition is met.

4. The method of claim 3, wherein the requested identifier comprises a plurality of markers located a specific distance from one another; and
wherein the predetermined condition comprises an indication that markers of the applied identifier are in one-to-one correspondence with the plurality of markers of the requested identifier.

5. The method of claim 3, further comprising:
receiving, by the server, a second graphic image comprising an unknown artwork;
analysing the second graphic image to detect one or more identifiers applied therein;
comparing the one or more detected identifiers in the second graphic image with one or more stored records; and
retrieving, based on the one or more detected identifiers corresponding to the applied identifier of the graphic image, a record identifying the artwork as being applied to the particular substrate.

6. The method of claim 5, wherein comparing the one or more detected identifiers in the second graphic image with one or more stored records comprises:
generating a margin of error for each identifier of the one or more stored records;
comparing a distance of the one or more detected identifiers with each identifier of the one or more stored records, and
when the distance of the one or more detected identifiers are within the margin of error of a stored identifier, establishing a one-to-one correspondence.

7. The method of claim 1, further comprising:
receiving, by the server from a computing device, a second graphic image comprising an unknown artwork;
analysing the second graphic image to detect one or more identifiers applied therein;
comparing the one or more detected identifiers in the second graphic image with one or more stored records;
when the one or more detected identifiers do not correspond to the one or more stored records, retrieving information corresponding to a detected artwork in the second graphic image.

8. The method of claim 7, wherein comparing the one or more detected identifiers in the second graphic image with one or more stored records comprises:
generating a margin of error for each identifier of the one or more stored records;
comparing a distance of the one or more detected identifiers with each identifier of the one or more stored records; and
when the distance of the one or more detected identifiers are outside the margin of error for each identifier of the one or more stored records, analysing the second graphic image to identify the detected artwork.

9. The method of claim 1, further comprising:
analysing the artwork to determine if one or more stored records exists for the artwork, each of the one or more stored records having unique identifiers; and
generating the instructions for a graphic applicator to apply the identifier such that the identifier will be distinct from the unique identifiers of the one or more stored records.

10. The method of claim 9, wherein generating the instructions comprises:
generating a margin of error for each unique identifier of the one or more stored records; and
generating a plurality of regions to indicate where each applied identifier would be distinct from the one or more stored records.

11. The method of claim 1, wherein the instructions include a candidate region for placement of the identifier in the artwork.

12. The method of claim 1, wherein the identifier comprises a plurality of markers located a specific distance from one another.

13. The method of claim 1, further comprising:
receiving, from the graphic applicator device before application of the artwork to the particular substrate, a validation image depicting the artwork with an intended identifier;
comparing the intended identifier to one or more stored records; and
confirming the intended identifier is distinct from the one or more stored records.

14. A system, comprising:
a processor; and
memory storing computer readable instructions which, when executed by the processor, configure the system to manage application of artwork to a substrate by:
receiving, from a user, a request to include an identifier in an artwork;
sending, to a graphic applicator device and in response to the indication, instructions for applying the requested identifier to a substrate;
receiving, from the graphic applicator device, a graphic image depicting the artwork as applied to a particular substrate;
detecting an applied identifier in the graphic image; and
sending, to the graphic applicator device, a confirmation that the applied identifier corresponds to the requested identifier when a predetermined condition is met.

15. The system of claim 14, wherein the instructions which, when executed by the processor, further configure the system to manage application of artwork to a substrate by:
storing a record identifying the artwork as being applied to the particular substrate when the predetermined condition is met.

16. The system of claim 15, wherein the identifier comprises a plurality of markers located a specific distance from one another; and
wherein the confirmation indicates a location of a plurality of markers of the applied identifier being in one-to-one correspondence with the plurality of markers of the requested identifier; and
wherein the predetermined condition comprises the confirmation.

17. The system of claim 15, wherein the instructions which, when executed by the processor, further configure the system to manage application of artwork to a substrate by:
receiving a second graphic image comprising an unknown artwork;
analysing the second graphic image to detect one or more identifiers applied therein;
comparing the one or more detected identifiers in the second graphic image with one or more stored records;
retrieving, based on the one or more identifiers corresponding to the requested identifier of the graphic image, a record identifying the artwork as being applied to the particular substrate.

18. The system of claim 17, wherein comparing the one or more detected identifiers in the second graphic image with one or more stored records comprises:
generating a margin of error for each identifier of the one or more stored records;
comparing a distance of the one or more detected identifiers with each identifier of the one or more stored records, and
when the distance of the one or more detected identifiers are within the margin of error of a stored identifier, establishing a one-to-one correspondence.

19. The system of claim 14, wherein the instructions which, when executed by the processor, further configure the system to manage application of artwork to a substrate by:
analysing the artwork to determine if one or more stored records exists for the artwork, each of the one or more stored records having unique identifiers; and
generating the instructions for a graphic applicator to apply the identifier such that the identifier will be distinct from the unique identifiers of the one or more stored records.

20. The system of claim 14, wherein the instructions which, when executed by the processor, further configure the system to manage application of artwork to a substrate by:
receiving, from the graphic applicator device before application of the artwork to the particular substrate, a validation image depicting the artwork with an intended identifier;
comparing the intended identifier to one or more stored records; and
confirming the intended identifier is distinct from the one or more stored records.
